(19) United States
(12) Patent Application Publication
(10) Pub. No.: US 2008/0147328 A1
(43) Pub. Date: Jun. 19, 2008

(54) Generating a Geographic Representation of a Network of Seismic Devices

(76) Inventors: Jun Wang, Houston, TX (US); Stuart Papworth, Asker (NO); Sven Furberg, Snaroya (NO); Thorleiv Knutsen, Asker (NO)

Correspondence Address: WesternGeco L.L.C.;Jeffrey E. Griffin, 10001 Richmond Avenue, HOUSTON, TX, 77042-4299, US

(21) Appl. No.: 11/754,125

(22) Filed: May 25, 2007

Related U.S. Application Data
(60) Provisional application No. 60/870,269, filed on Dec. 15, 2006.

(51) Int. Cl. G01V 1/34

(52) U.S. Cl. 702/16

(57) ABSTRACT

Information from a network of seismic device is received, and a geographic representation of the network of seismic devices is generated. The geographic representation contains information regarding the seismic devices.

The current non-provisional patent application claims the priority of co-pending provisional patent application, attorney docket number 14.0313-US-PRO, Ser. No. 60/870,269, filed on Dec. 15, 2006 by the same inventors, with the same title.

### TECHNICAL FIELD

The invention relates generally to generating a geographic representation of a network of seismic devices.

### BACKGROUND

Seismic surveying is used for identifying subterranean elements, such as hydrocarbons, fresh water, and so forth. In performing seismic surveying, seismic sources are placed at various locations on an earth surface or sea floor, with the seismic sources activated to generate acoustic waves directed into a subterranean structure. Examples of seismic sources include explosives or other sources that generate acoustic waves.

The acoustic waves generated by a seismic source travel downwardly into the subterranean structure, with a portion of the acoustic waves reflected back to the earth surface (or sea floor) for receipt by seismic sensors (e.g., geophones). These seismic sensors produce signals that indicate detected seismic waves. Signals from the seismic sensors are processed to yield information about the content and characteristic of the subterranean structure.

Seismic devices (including seismic sources and seismic sensors) are typically arranged to cover an area that is to be investigated. In some scenarios, the number of seismic devices can be large, and the arrangement of seismic devices can be complex. As a result, monitoring and managing such seismic devices can be a relatively difficult task that is labor and time-intensive.

### SUMMARY

In general, a method comprises receiving information from a network of seismic devices, and generating a geographic representation of the network of seismic devices, where the geographic representation contains information regarding the seismic devices.

Other or alternative features will become apparent from the following description, from the drawings, and from the claims.

### BRIEF DESCRIPTION OF THE DRAWINGS

FIG. 1 illustrates an arrangement of seismic devices that are coupled to a geographic information system, in accordance with an embodiment.

FIG. 2 is a flow diagram of a monitoring process performed by the geographic information system, in accordance with an embodiment.

FIG. 3 is a flow diagram of a control process performed by the geographic information system, in accordance with an embodiment.

FIG. 4 illustrates graphical user interface (GUI) screens generated by the geographic information system, according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

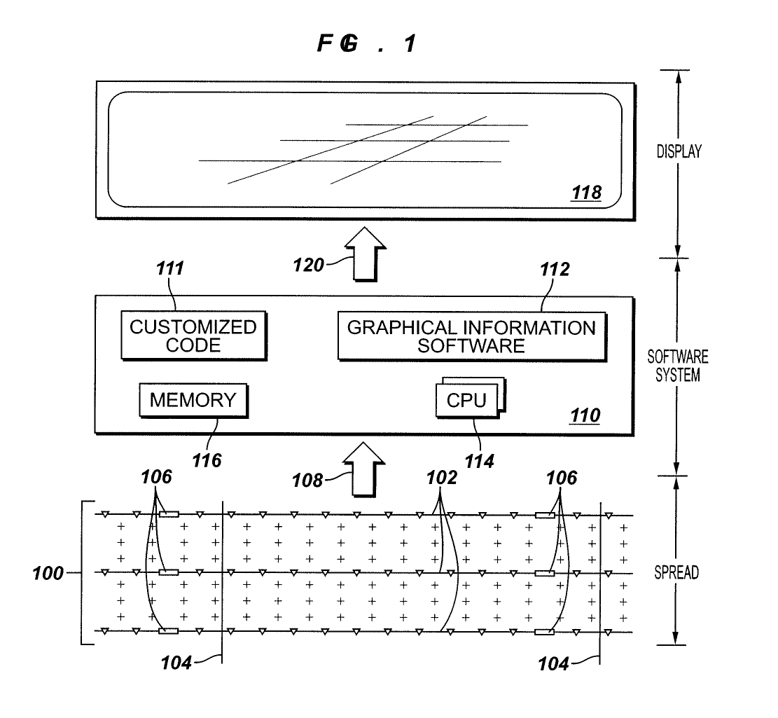

FIG. 1 illustrates a network 100 of seismic devices. The term “seismic device” refers to any one or more of: a seismic source (e.g., an explosive, air gun, vibrator, or some other source for producing acoustic waves directed into a subterranean structure); a seismic sensor (e.g., a geophone or any other receiving device for receiving reflected acoustic waves from the subterranean structure); a communications device coupled to seismic sources and/or seismic sensors; a communications link coupling the seismic sources, seismic sensors; and communications devices, and a control unit to perform control tasks.

In some implementations, the network 100 of seismic devices is deployed in a shallow-water environment, where the seismic devices are located on a sea floor. In the subsea environment, the seismic devices are used for investigating the subterranean structure underneath the sea floor. In alternative implementations, the network 100 of seismic devices can be deployed on land, in which case the seismic devices are used for investigating the subterranean structure under land.

In the network 100 of FIG. 1, the upside down triangular symbols represent seismic sensors, and the “+” symbols represent seismic sources. The seismic sensors are coupled by communications links 102 (three depicted in FIG. 1). Although not depicted, the seismic sources are also coupled to communications links to allow the seismic sources to be remotely activated. The communications links 102 run generally in the horizontal direction in FIG. 1 (to correspond to rows of seismic sensors). In the vertical (or column) direction, transport links 104 are used to couple the rows of seismic devices. Note that the communications links 102 and transport links 104 can have different arrangements from the horizontal and vertical arrangements depicted in FIG. 1, in accordance with other embodiments.

Also depicted in FIG. 1 are seismic bridging units (SBUs) 106, which are used to bridge one segment of a communications link 102 to another segment of the communications link 102. The SBUs 106 are used to break up communications links 102 into segments such that each segment of the communications link is not too long, which can cause excessive resistance that adversely affects communications over the communications links 102. Instead of an SBU 106, other embodiments can use other types of routing devices for connecting segments of communications links 102. Although not depicted, the transport communications links 104 can also have routing devices.

The network 100 of seismic devices (or some part of the network 100) can be referred to as a “spread.” A spread can be live (in which case the spread is acquiring data, such as by measuring acoustic waves), or a spread can be inactive (in which case the spread is not acquiring data). Also, at different times, a spread can have different states (e.g., live, inactive, etc.). The term “spread” or “seismic spread” is a logical and/or physical representation of at least a portion of the network 100. In accordance with some embodiments, a spread can be represented in geographic format to allow for convenient and efficient monitoring and analysis of states of the seismic devices, as well as relationships among the seismic devices. Also, seismic devices in the spread can also be controlled using the geographic information system according to some embodiments.

The network 100 of seismic devices is connected by a communications link 108 to a geographic information system 110. The communications link 108, in one implementation, is a wireless communications link to allow for remote communication between the network 100 and the geographic information system 110. In alternative implementations, the communications link 108 can be a wired communications link, or even a fiber optic communications link. The geographic information system 110 includes geographic information software 112 executable on one or plural central processing units (CPUs) 114 in the geographic information system 110. The CPU(s) 114 is (are) connected to memory 116 in the geographic information system 110, where the memory 116 can be implemented as volatile memory (e.g., dynamic random access memories, static random access memories, etc.) or with persistent storage devices (e.g., optical or magnetic disk-based storage devices).

The geographic information system 110 is coupled to a display device 118 over a communications link 120. The display device 118 can be a local display device 118 that is directly attached to the geographic information system 110. Alternatively, the display device 118 is located at a client station that is at a remote location with respect to the geographic information system 110. In the latter case, the communications link 120 can be a network, such as a local area network (LAN), wide area network (WAN), or the Internet. In fact, in some implementations, multiple client stations can be used to connect to the geographic information system 110 to allow users at different locations to communicate with the geographic information software 112 for the purpose of monitoring and/or managing the spread in the network 100 of seismic devices.

A benefit offered by some embodiments of the invention is that the geographic information system 110 can easily monitor a relatively large-scale seismic spread. In fact, in some embodiments, the monitoring of the seismic spread can be performed in real time, where “real time” refers to the ability to substantially receive updates of the network 100 of seismic devices as conditions change. “Real time” refers to the ability to receive updates in a matter of seconds, minutes, or hours (rather than days, weeks, or months).

In some embodiments, the geographic information software 112 can be a commercial, off-the-shelf software that is readily available. This provides the benefit of allowing for easy implementation of a technique for representing the seismic spread. An example of an off-the-shelf geographic information software is the ArcGIS desktop software from Enviromnental Systems Research Institute, Inc. (ERSI). The off-the-shelf geographic information software 112 is able to cooperate with customized code 111 that is provided to provide desired features for monitoring and/or managing a seismic spread. For example, the customized code 111 can be used to provide real-time monitoring, layering (discussed further below), partial refresh (discussed further below), and other features. In one example implementation, the geographic information software 112 provides an application programming interface (API) that allows interaction with the customized code 111. The customized code 111 can include one or plural software modules. The collection of the geographic information software 110 and customized code 111 is referred to as a “geographic information package.”

The geographic information package is able to generate a geographic representation of the terrain on which the network 100 of seismic devices is located. In addition, the geographic information package is able to provide a geographic rendering of the seismic devices, which rendering allows a user to view the state of the seismic devices. Also, seismic measurements taken by seismic sensors can also be visualized in the rendered geographic representation provided by the geographic information package. In some embodiments, the geographic representation is in the form of graphical user interface (GUI) screens, such as GUI screens presented by a web browser or by other software applications.

The geographic information package also provides a layering feature to allow for performance of complex spatial relationship analysis. The layering feature allows a user to visualize the network 100 in a logical manner, such as grouping the seismic devices into different logical groups. Also, the geographic information package is able to represent information relating to the states of the various seismic devices. For example, the states can include alarms associated with the seismic devices, with the alarms including different types of alarms. In one implementation, the layering feature provided by the geographic information package can provide different layers (groups) associated with the different types of alarms. In other implementations, other types of logical grouping can be performed.

In one example, one type of alarm can be associated with seismic sensors, another type of alarm can be associated with communications devices, and so forth. The different alarm types are thus associated with different logical layers, such that a user can easily view different information in the different logical layers. In one implementation, the different logical layers can have different colors, so that a user can quickly ascertain the states associated with seismic devices in the spread, which eases analysis of a complex spread. As an example, if a user is interested in monitoring the status of seismic sensors, the user can quickly look for the particular color associated with the logical layer of the seismic sensors to determine the states of the various seismic sensors.

Also, the geographic representation presented by the geographic information package can indicate the severity of each alarm condition by using different rendering symbols. For example, a critical alarm can be represented with one type of symbol, while a less critical alarm can be represented with a different symbol.

The geographic information package also is able to track the boundaries of updated features in each layer, such that only the portions of each layer that have been updated are refreshed. The ability to track boundaries of updated features (portions of the network) allows for provision of a partial refresh of each layer to reflect the current state. Partially refreshing a layer (as opposed to refreshing the entire layer) allows for more efficient refreshing and less bandwidth requirements in communications links (such as the communications links 108 and 120). In this manner, a large amount of data associated with the seismic spread can be displayed as geographic representations in real time, with relatively high updating frequency.

As noted, the geographic information package can present a logical view of a spread. Alternatively, the spread can be depicted in a physical view with real geometrical coordinates in the geographic representation. In addition to seismic devices, a more comprehensive view can be provided by the geographic information package, including vehicles and other objects associated with performing seismic operations.

Attributes associated with various seismic devices can also be tracked. The attributes can be presented in the geographic representation, or alternatively, a user can select GUI control items to cause a presentation of the desired attributes associated with selected one or more seismic devices.

In addition to monitoring states of seismic devices, the geographic information package can also be used to perform control tasks, including power management for the seismic spread to achieve power consumption. For example, if a particular part of the network 100 is no longer being used, then that particular part of the network can be used for setting up the next spread (or be disabled). The geographic information package can also be used to optimize resource usage, where the geographic information package can provide advice regarding the optimal usage of a resource based on spatial analysis, which includes guiding spread maintenance crews (such as directing maintenance crews to a particular location in the spread to perform maintenance tasks), setting spread layout (such as suggesting layouts of the spread that would be more efficient), and so forth.

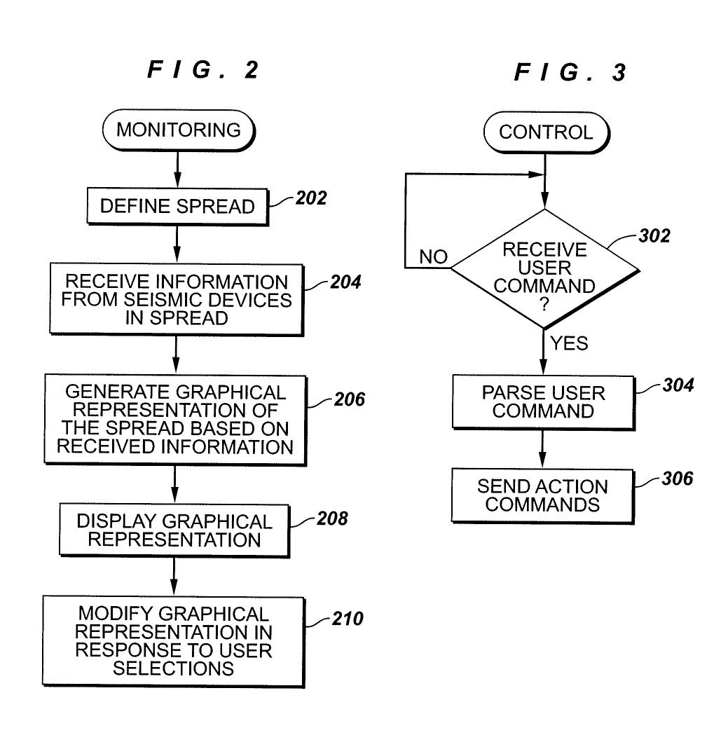

FIG. 2 illustrates a flow diagram of a monitoring task performed by the geographic information package, in accordance with an embodiment. First, a particular spread is defined (at 202). The particular spread can be defined by a user using a GUI screen provided by the geographic information package. Note that multiple spreads can be defined for the network 100 of seismic devices. Next, in an acquisition stage, the geographic information package receives (at 204) information from seismic devices in the particular spread. A geographic representation is then generated (at 206) by the geographic information package of the spread, based on the received information.

An example of a geographic representation is shown in FIG. 4. The geographic representation can include various GUI screens (or one GUI screen with several frames), with one screen 400 showing the entire spread, while another screen 402 can be used to represent a portion of the spread. Also, other screens 404, 406 can be used to display other information relating to the seismic devices, including alarm information, information indicating which elements to display, and so forth.

The screen 404 in FIG. 4 shows a table of content, which lists types of information associated with the spread. The table of content has user-selectable boxes 405 that a user can select to indicate the types of information to display in the screen 402. As shown in the table of contents screen 404, each type of information is associated with different icons 405 that can be displayed in the screen 402.

Screen 406 shows seismic sensors in row “10,” along with corresponding column positions (e.g., 380, 381, 382, etc.). Although an example geographic representation is shown in FIG. 4, it is noted that other implementations can include other forms of geographic representations, including representations in table format, pie chart format, graph format, and so forth.

The generated geographic representation is then displayed (at 208) on the display device 118, which can be a local display device connected to the geographic information system 110 or a remote display device associated with a client station. The geographic representation can be modified (at 210) in response to user selections in the displayed image (such as due to selection of control items, menu items, and so forth).

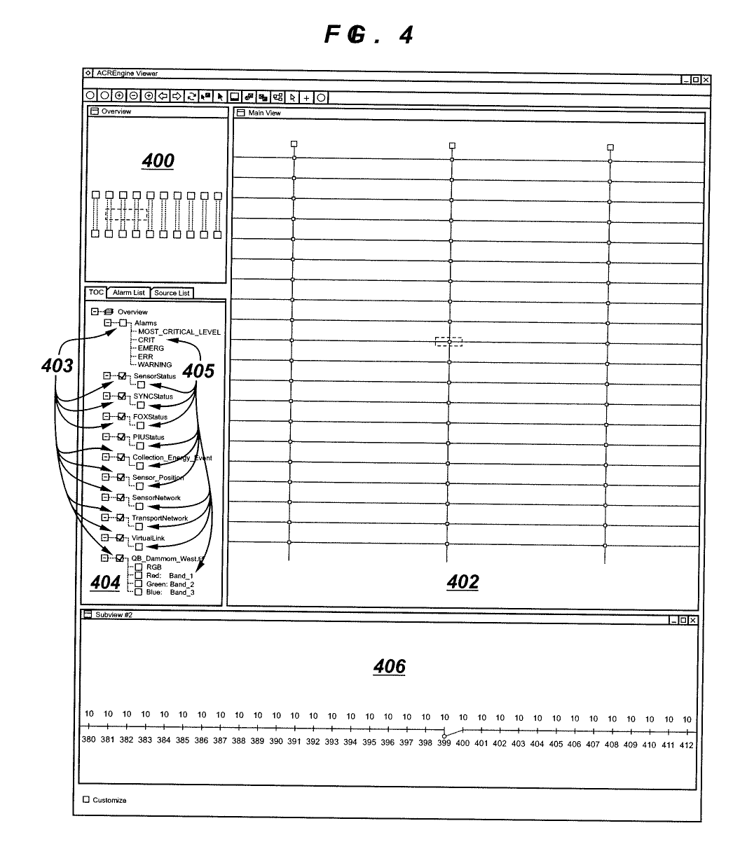

FIG. 3 shows a flow diagram of a process for controlling a particular spread. The geographic information package determines (at 302) if a user command has been received. The user command can be entered through a command line prompt, or received through selection of a GUI control icon in a GUI screen. If a user command is received, the command is parsed (at 304). The parsed command is converted into one or more actions (represented by action commands), which are sent (at 306) by the geographic information package to the particular spread over communications link 108 in FIG. 1. In response to the action commands, the corresponding seismic devices (such as seismic sources, seismic sensors, communications devices, and/or control units) perform the requested actions.

By using the geographic information package according to some embodiments, various benefits can be provided. For example, by using off-the-shelf geographic information software, implementation can be made more quickly and in a more cost-efficient manner. With the geographic information package, users can also more effectively monitor and manage seismic spreads.

Instructions of software described above (including geographic information software 112 and customized code 111 of FIG. 1) are loaded for execution on a processor (such as one or more CPUs 114 in FIG. 1). The processor includes microprocessors, microcontrollers, processor modules or subsystems (including one or more microprocessors or microcontrollers), or other control or computing devices.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art will appreciate numerous modifications and variations there from. It is intended that the appended claims cover such modifications and variations as fall within the true spirit and scope of the invention.

What is claimed is:

1. A method comprising:
receiving information from a network of seismic devices; and
generating a geographic representation of the network of seismic devices, the geographic representation containing information regarding the seismic devices.

2. The method of claim 1, wherein receiving the information and generating the geographic representation are performed by a geographic information system that communicates with the network of seismic devices over a link.

3. The method of claim 1, further comprising representing a spatial relationship of the seismic devices in the geographic representation.

4. The method of claim 1, further comprising presenting alarms associated with at least some of the seismic devices in the geographic representation.

5. The method of claim 1, wherein generating the geographic representation comprises generating plural screens depicting different information associated with the network of seismic devices.

6. The method of claim 1, wherein the geographic representation contains information pertaining to the states of the seismic devices, the method further comprising partially refreshing the geographic representation to reflect updates to the states of the seismic devices.

7. The method of claim 1, wherein generating the geographic representation comprises generating the geographic representation having plural layers to represent different logical groups.

8. The method of claim 7, further comprising depicting the plural layers using different colors.

9. The method of claim 1, wherein generating the geographic representation of the network of seismic devices comprises generating the geographic representation of a spread corresponding to at least a subset of the network of seismic devices.

10. The method of claim 9, further comprising indicating the spread as having a live state when the seismic devices of the spread are acquiring seismic data, and indicating the spread as inactive when the seismic devices of the spread are not acquiring seismic data.

11. The method of claim 9, further comprising:
maintaining multiple spreads,
wherein generating the geographic representation comprises generating the geographic representation of the multiple spreads.

12. The method of claim 1, wherein generating the geographic representation of the network of seismic devices comprises generating the geographic representation of the network of seismic devices including seismic sources, seismic sensors, communications devices, communications links, and control units.

13. An article comprising at least one storage medium containing instructions that when executed cause a system to:
receive information from a network of seismic devices; and
generate a geographic representation of the network of seismic devices, the geographic representation containing information regarding the seismic devices.

14. The article of claim 13, wherein the instructions when executed cause the system to:
receive user commands; and
in response to the user commands, provide action commands to the network of seismic devices.

15. The article of claim 13, wherein generating the geographic representation of the seismic devices comprises generating the geographic representation of plural logical groups of the seismic devices to allow more convenient monitoring of the network of seismic devices.

16. The article of claim 15, wherein the logical groups are associated with different alarm types.

17. The article of claim 13, wherein the instructions when executed cause the system to further:
tracking updated portions of the network of seismic devices; and
partially updating the geographic representation according to the tracked updated portions.

18. The article of claim 13, wherein the seismic devices comprise seismic sources, seismic sensors, communications devices, communications links, and control units.

19. A system comprising:
a network of seismic devices;
a geographic information system; and
a communications link coupling the geographic information system to the network of seismic devices,
wherein the geographic information system is configured to:
receive seismic data from the seismic devices; and
generate a geographic representation of the network of seismic devices, wherein the geographic representation contains information relating to the seismic devices.

20. The system of claim 19, wherein the information contained in the geographic representation comprises states of the seismic devices and measurement data acquired by the seismic devices.

21. The system of claim 19, wherein the geographic information system comprises an off-the-shelf geographic information software and customized code to interact with the off-the-shelf geographic information software.
